(19) United States
(12) Patent Application Publication
(10) Pub. No.: US 2005/0012357 A1
(43) Pub. Date: Jan. 20, 2005

(54) Motor vehicle with a convertible rear compartment

(76) Inventor: Richard Miller, Atlantic Beach, FL (US)

Correspondence Address: Mark J. Young, Suite 227, 9951 Atlantic Blvd., Jacksonville, FL, 32225, US

(21) Appl. No.: 10/858,333

(22) Filed: Jun. 1, 2004

Related U.S. Application Data
(60) Provisional application No. 60/474,977, filed on Jun. 2, 2003.

(51) Int. Cl. B60J 7/14; B60J 7/00

(52) U.S. Cl. 296/107.17

(57) ABSTRACT

A versatile vehicle has a hinged roof panel that may be opened and locked at a bulkhead, behind the rear seat of a front compartment, mating with a bulkhead frame and thereby sealing off the front compartment from a rear compartment. The rear compartment may be configured with seats for carrying passengers. The seats may be collapsible and/or removable, thereby enabling the rear compartment to be converted into a cargo area by collapsing or removing the seats. An additional roof panel may be provided for converting the rear compartment from an enclosed compartment to an open-air compartment while the first roof panel is locked against the bulkhead frame. A kit is also provided for converting a conventional SUV into an SUV having such features.

### RELATED APPLICATIONS

This application claims priority to U.S. Provisional Application 60/474,977, filed Jun. 2, 2003, the entire contents of which are hereby incorporated by reference herein.

### BACKGROUND

1. Field of the Invention

The invention relates to motor vehicles and, more particularly, to a versatile sport-utility vehicle, station wagon or van having a roof panel that may be opened and locked in place at a bulkhead, behind the rear seat of a front compartment, thereby sealing the front compartment from a rear compartment that may be converted from a rear passenger-carrying area to rear cargo carrying compartment, each of which may be enclosed or open-air.

2. Background Description

Sport-utility vehicles, station wagons and vans, which are referred to collectively hereinafter as SUVs, have grown tremendously in popularity. Many consumers favor the interior space available in such vehicles. While such vehicles are quite versatile, their spacious interiors suffer shortcomings. For example, closed rear compartments of SUVs do not accommodate upright tall objects.

In sharp contrast, a cargo bay of a pick-up truck can easily carry objects that are substantially taller than the roof of the vehicle, but has very limited interior space. Additionally, the cargo bay of a pick-up truck is typically not enclosed and not equipped for carrying passengers.

Furthermore, because rear compartments of SUVs are not sealed from front compartments, there is significant risk of unintended intrusions of cargo, noise, dirt and cargo-related odors into the front compartment. Not only can such intrusions create a nuisance and soil a front compartment, but they may also present a health hazard and safety risk.

SUVs having roof openings in rear compartments are known in the art. Although such vehicles may accommodate tall objects, they do not include a cost-effective apparatus for efficiently and securely sealing the open-air rear compartment from the front compartment.

The invention is directed to overcoming one or more of the problems as set forth above.

### SUMMARY OF THE INVENTION

The invention solves the problems and/or overcomes the drawbacks and disadvantages of the prior art by providing, in one exemplary embodiment, a vehicle having a hinged roof panel that may be opened and locked at a bulkhead, behind the rear seat of a front compartment, thereby sealing off the front compartment from a rear compartment.

In another exemplary embodiment, a kit is provided for converting a conventional SUV into an SUV having a hinged roof panel that may be opened and locked at a bulkhead, behind the rear seat of a front compartment, thereby sealing off the front compartment from a rear compartment.

The rear compartment may be configured as a passenger compartment that can be converted into a cargo compartment, such as by collapsing or removing seats. The rear compartment may also be configured as an enclosed compartment, with an exterior roof panel sealing a roof opening above the rear compartment. The exterior roof panel may be adapted for pivotal movement and locking against an interior panel at the bulkhead. Additionally (or in the alternative), the exterior roof panel may be retractable, i.e., adapted for sliding motion substantially parallel to the fixed roof. Upon sliding the retractable exterior roof panel forward, the rear compartment may be converted into an open-air compartment.

### BRIEF DESCRIPTION OF THE DRAWINGS

The foregoing and other objects, features and advantages of the present invention will become better understood with reference to the following description, appended claims, and accompanying drawings, where:

FIG. 1 conceptually provides a top view of a portion of a vehicle roof with a exemplary roof panel that may be opened in accordance with an embodiment of the invention;

FIG. 2 conceptually provides a rear view of a vehicle with a cutaway section of the roof, the roof being equipped with an exemplary hinged roof panel in an vertical (i.e., folded down) position, thereby creating a bulkhead sealing the cargo compartment from the front compartment;

FIG. 3 conceptually provides a side view of an a portion of an exemplary hinged roof panel in closed, intermediate and opened positions in accordance with an embodiment of the invention;

FIG. 4 conceptually shows a cutaway section of a portion of an exemplary roof panel and roof section in accordance with an embodiment of the invention;

FIG. 5 conceptually provides a top view of a portion of a vehicle roof with an exemplary roof panel that may be retracted in accordance with an embodiment of the invention;

FIG. 6 conceptually provides a top view of a portion of a vehicle roof with an exemplary roof panel that is retracted in accordance with an embodiment of the invention;

FIG. 7 provides a top view of a portion of a vehicle roof with an exemplary roof panel that is partially retractable and hinged in accordance with an embodiment of the invention;

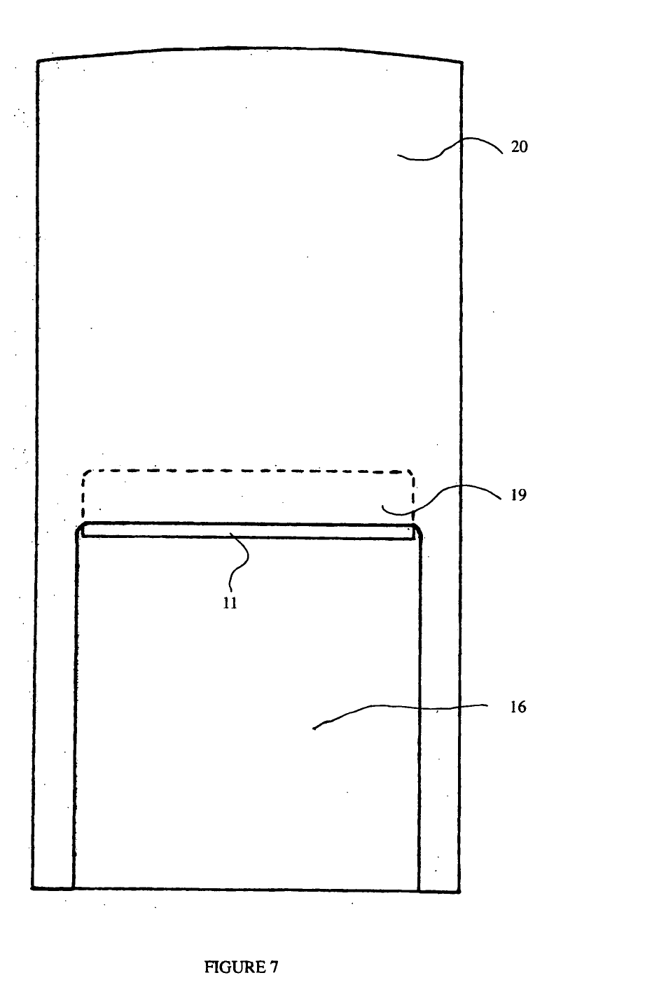

FIG. 8 conceptually provides a rear view of a vehicle with a cutaway section of the roof, the roof being equipped with an exemplary hinged roof panel in a closed position, thereby sealing the roof opening;

FIG. 9 conceptually provides a side view of a vehicle with a retractable roof panel in a closed position;

FIG. 10 conceptually provides a side view of a vehicle with a retractable roof panel in an opened position;

FIG. 11 conceptually provides a side view of a vehicle with a roof panel having a plurality of hingedly joined sections in an opened position; and

FIG. 12 conceptually provides a side view of a hinged roof panel comprised of an interior roof panel and an exterior roof panel, each of which may be independently pivoted.

### DETAILED DESCRIPTION OF EMBODIMENTS OF THE INVENTION

An exemplary embodiment of the invention provides an apparatus for sealing an interior rear compartment from an interior front compartment of an SUV. An SUV includes an interior with a front compartment containing one or more rows of passenger seats. The SUV also includes a rear compartment, which may also include one or more rows of passenger seats. The rear compartment passenger seats may be removable and/or collapsible. With the passenger seats in place and an exterior roof panel in the closed position, the rear compartment becomes a separate area sealed from the front compartment and the elements. By removing or collapsing the passenger seats and opening the roof panel, the compartment converts into an open-air cargo carrying area.

A bulkhead is the demarcation between the front compartment and the rear compartment. In a preferred implementation, the bulkhead is located behind the front compartment passenger seat(s), but ahead of the side windows of the rear compartment. Location of the bulkhead at the side windows would create aesthetic and structural issues.

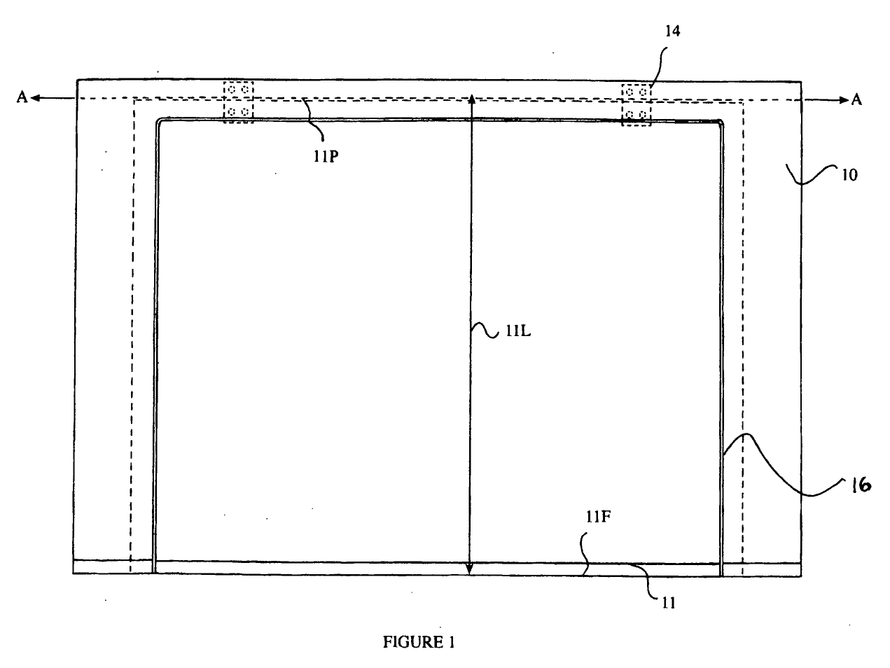

According to an embodiment of the invention, a roof panel from above the rear compartment may be opened and positioned to function as part of the bulkhead, thus partitioning a front compartment from a rear compartment. Referring now to FIG. 1, a top view of a portion of a vehicle roof with an exemplary roof panel 11 that may be opened in accordance with an embodiment of the invention is shown. The roof panel 11 is received within an opening 16 defined in the roof 10 above the rear compartment of the vehicle. In an exemplary embodiment, the roof panel is pivotally mounted at or adjacent to the front (pivotal) edge 11P of the panel. Hinges 14 (or other pivot devices) may be used for pivotal mounting. Thus, the panel may pivot about axis A-A at or near the front edge 1P of the roof panel 11. Conventional seals may be provided to ensure a weatherproof seal between the roof panel 11 and the roof 10. A conventional locking apparatus may also be provided to lock the roof panel 11 in a closed position.

The roof panel 11 may be comprised of a wide array of materials suitable for a roof component. By way of example and not limitation, the roof panel 11 may be composed of metals, plastics and/or glass and constructed in a manner suitable for conventional sunroofs or moon-roofs.

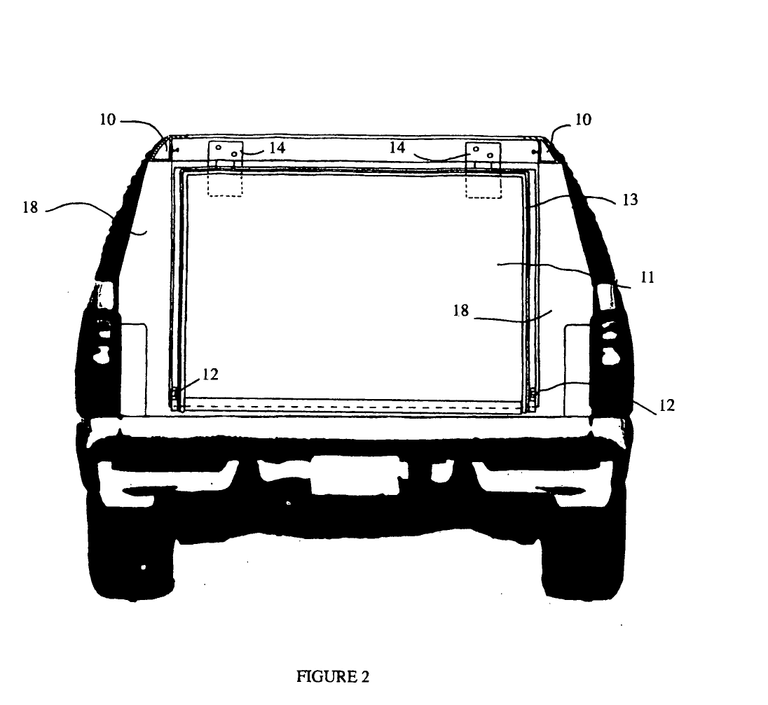

In one exemplary implementation, the roof panel 11 is sized to mate with a bulkhead frame 18 (as shown in FIG. 2 and described below). In an exemplary embodiment, the length 11L of the roof panel 11 is approximately equal to or slightly less than the distance from the roof to the floor. Thus, when the roof panel 11 is open, the free end 11F may be pivoted downwardly so that the roof panel 11 is in a substantially vertical orientation. The free end 11F of the roof panel 11 extends to the back of the rear compartment and abuts the top of the tailgate. As used herein, the term tailgate denotes a gate (e.g., door) at the rear of the vehicle that can be lowered or swung open for access to the rear compartment. Conventional seals may be provided to ensure a weatherproof seal between the free end 11F of the roof panel 11 and the tailgate. The width of the exemplary roof panel 11 (as measured perpendicular to the length 11L) is approximately equal to or slightly less than the minimum width of the interior of the rear compartment (i.e., the distance from one side, e.g., driver's side, of the rear compartment to the other side, e.g., passenger's side) at the bulkhead. The roof panel 11 should fit within the available area and mate with the bulkhead frame 18.

The roof panel 11 preferably includes one or more mechanisms for enabling locking. The exemplary roof panel 11 is configured for locking to the roof 10, as well as to or against the bulkhead frame 18 (as shown in FIG. 2 and described below). By way of example and not limitation, the sides and/or free end of the roof panel 11 may be equipped with lock assemblies 12 or lock strikers 15 configured to engage corresponding locking members at or near the roof 10 and bulkhead frame 18.

FIG. 2 conceptually provides a rear view of a vehicle with a cutaway section of the roof, the roof being equipped with an exemplary hinged roof panel in a vertical (i.e., folded down) position, thereby creating a bulkhead sealing the cargo compartment from the front compartment. As shown in FIG. 2, the roof panel 11 may be unlocked, released from the roof 10 and pivoted about axis A-A to expose the roof opening 16.

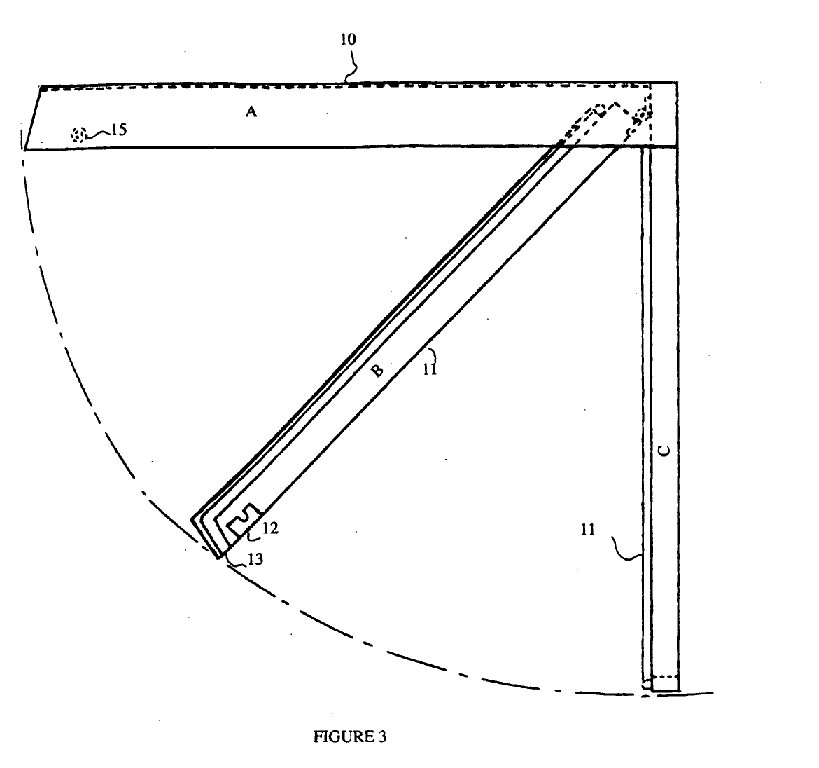

The roof panel may be opened or closed creating an open-air rear compartment or an enclosed rear compartment, respectively. Referring now to FIG. 3, a side view of a portion of an exemplary hinged roof panel in closed A, intermediate B and opened C positions in accordance with an embodiment of the invention is shown. Opening, closing, locking and unlocking may be performed automatically, such as by using electromechanical actuators and/or drives, or manually. When the roof panel 11 is released from the roof 10, the roof panel is considered to be opened and the rear compartment is said to be an open-air rear compartment. When the roof panel 11 is locked, sealing the roof opening 16, the roof panel is considered to be closed and the rear compartment is said to be an enclosed rear compartment.

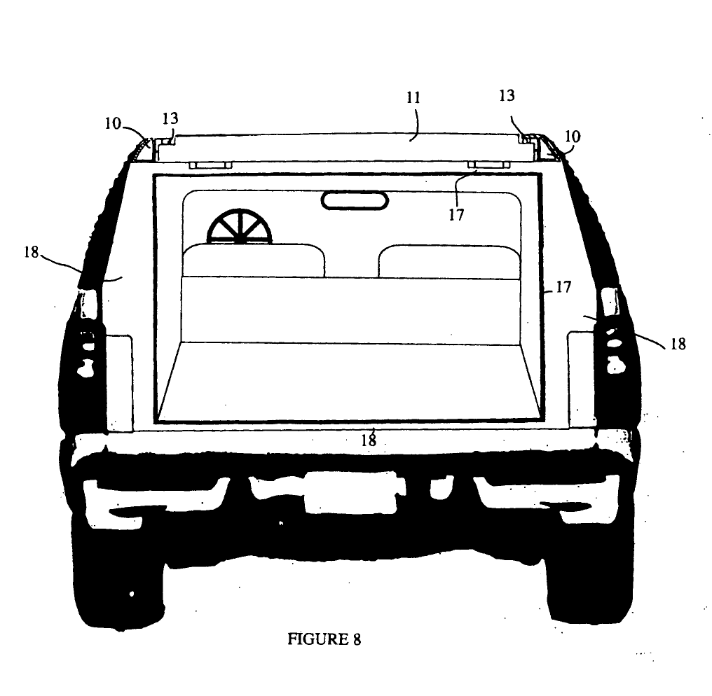

Illustratively, FIG. 8 conceptually provides a rear view of a vehicle with a cutaway section of the roof, the roof being equipped with an exemplary hinged roof panel in a closed position, thereby sealing the roof opening. A seal 17 is provided for enabling weatherproof seal between the roof panel 11 and the bulkhead frame 18.

As shown in FIG. 2, a bulkhead frame 18 partitions the front compartment from the rear compartment. The bulkhead frame 18 defines an opening for receiving the roof panel 11. When the roof panel 11 is locked to the bulkhead frame 18, the roof panel 11 and bulkhead frame 18 comprise a bulkhead that separates and seals the front compartment from the rear compartment. The bulkhead frame 18 may be formed as an integral part of the vehicle's body, or as a separate frame that can subsequently be installed. Additionally, the bulkhead may be comprised of a single integral frame or a plurality of mechanically fastened frame elements.

The bulkhead is sized and shaped to seal the front compartment from the rear compartment. The specific dimensions and shape of the bulkhead frame 18 will depend upon the size and shape of the portion of the compartment within which it resides and upon the size and shape of the roof panel 11. The sides of the interior near the bulkhead may be vertically straight, slanted or some other contoured shape. For example, depending upon the vehicle, the width of the rear compartment near the roof at the bulkhead may be different than the width of the rear compartment near the floor at the bulkhead.

The bulkhead, which is comprised of the roof panel 11 and bulkhead frame 18, provides several advantages. It protects the front compartment, reduces the level of noise and odors that enter the front compartment, and prevents cargo, soil and the elements from entering the front compartment.

A vehicle equipped with a bulkhead according to an exemplary embodiment of the invention, may include passenger seats in the rear compartment. Thus, the rear compartment may be used to transport passengers while the bulkhead isolates the rear compartment from the front compartment. Dividing the interior into a front passenger compartment and a rear passenger compartment is particularly useful for enhancing privacy, and segregating teenagers and/or loud passengers from quiet passengers. This compartment may also be used to segregate smoker from non-smokers.

The rear compartment may also be convertible into a cargo-carrying compartment. By way of example, the rear compartment may include collapsible or removable seats. Converting the rear compartment to a cargo-carrying compartment may entail removing or collapsing the passenger seats in the rear compartment.

A roof panel 11 according to an exemplary embodiment of the invention performs a plurality of functions. One such function is to comprise a substantial part of the bulkhead. Another function is to seal the roof opening 16, when the roof panel is not functioning as part of the bulkhead. Stationary or movable windows may be installed in the roof panel.

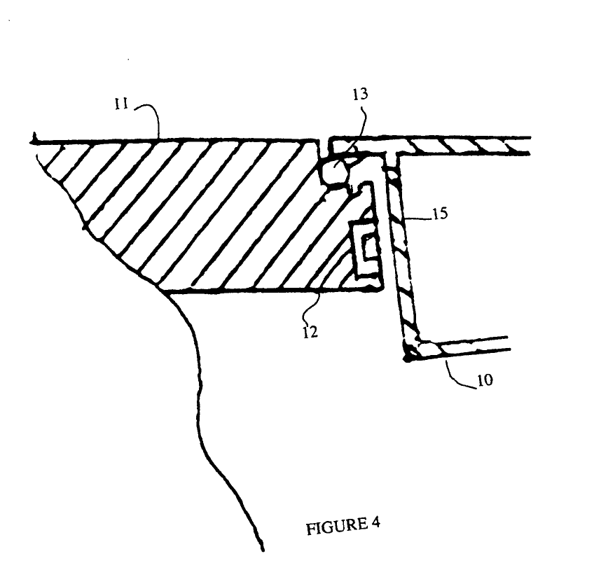

Referring now to FIG. 4, a cutaway section of a portion of an exemplary roof panel and roof section in accordance with an embodiment of the invention is shown. A seal 13 provides a weather-proof gasket between the panel 11 and roof 10.

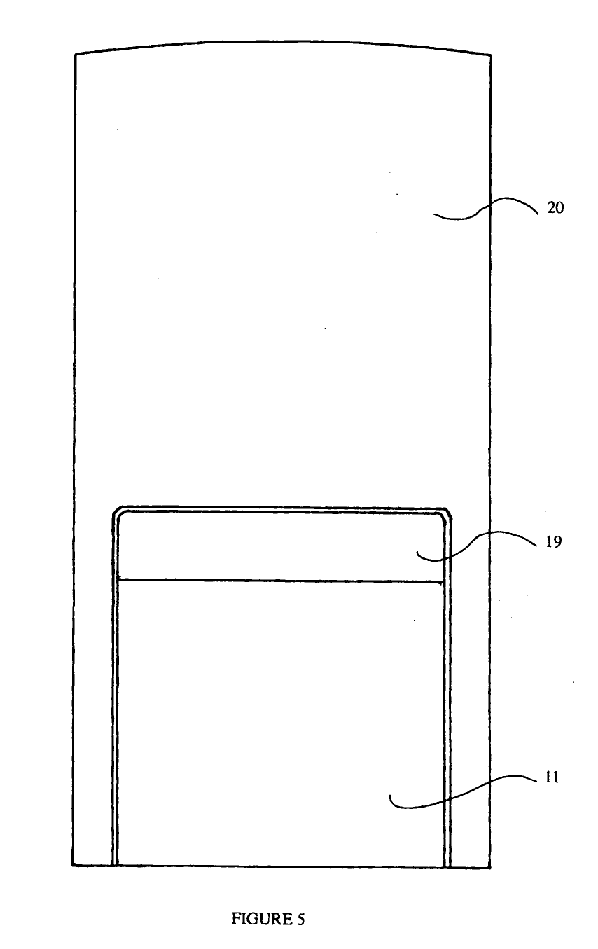

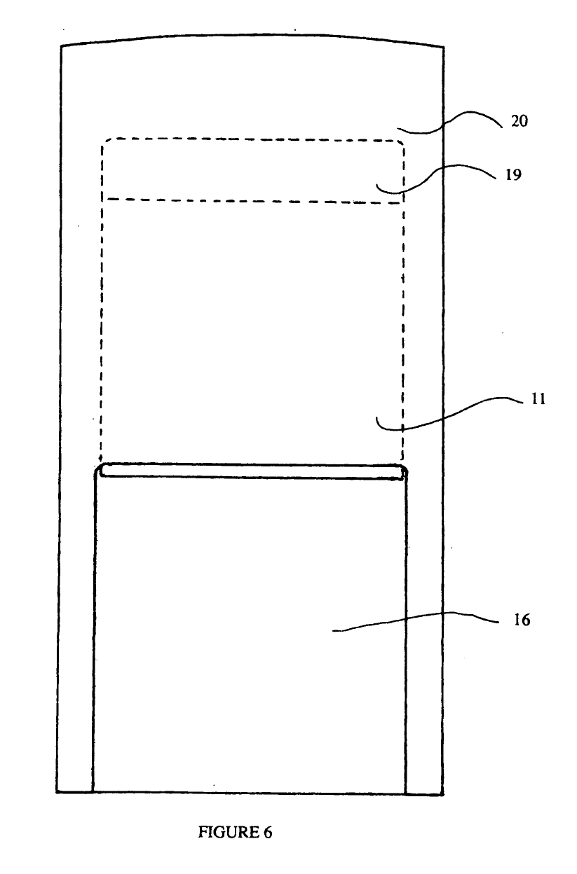

Alternative roof panel configurations which enable roof closure and bulkhead formation come within the scope of the invention. As an alternative embodiment, the roof panel may be fully or partially retractable. As used herein, retraction refers to sliding motion. A closed retractable roof panel may slide forward, thereby creating an opening. An open retractable roof panel may slide backward, thereby closing the opening. A retractable roof panel may slide into a pocket formed in an adjacent portion of the fixed roof, or may slide substantially parallel to, but slightly above, an adjacent portion of the fixed roof. Retraction of a roof panel may be accomplished in a conventional manner, such as mechanically and/or electromechanically using conventional devices for vehicle sunroofs and moon-roofs. By way of example, FIGS. 5-6 conceptually provide a top view of a portion of a vehicle roof with an exemplary roof panel 11 that may be fully or partially retracted in accordance with an embodiment of the invention. The roof panel may include a plurality of sections 11 and 19, with one section 11 hingedly attached to another section 19, both of which may be retracted substantially parallel to the roof portion 20, creating opening 16.

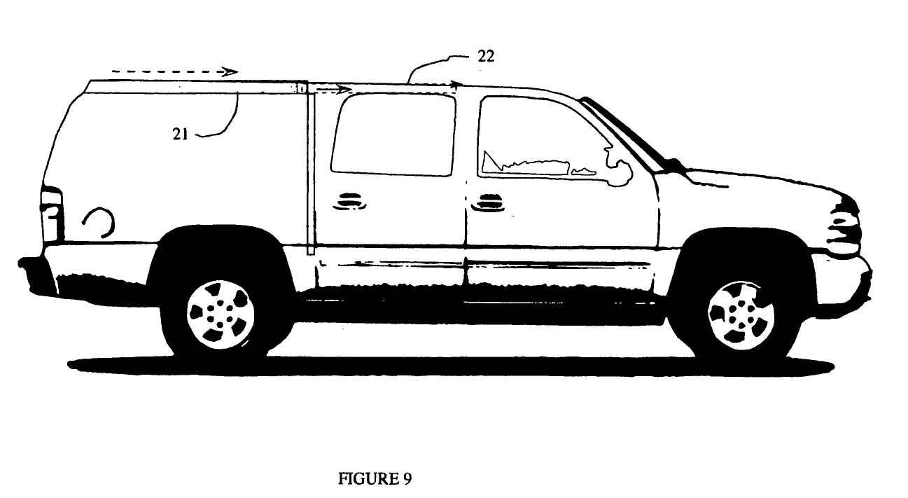

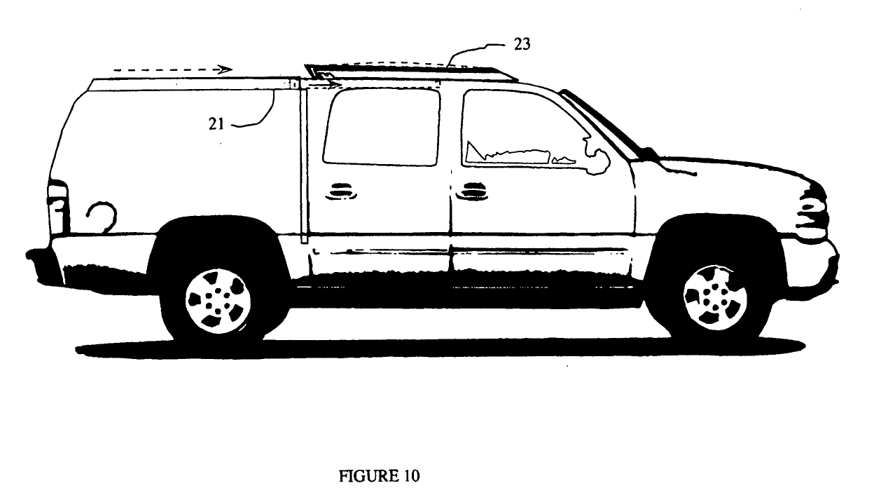

In long vehicles, an alternative embodiment may be used to avoid placement of the bulkhead by the side windows of rear compartment. If the distance from the bulkhead to the tailgate exceeds the distance from the roof to the floor, and the opening 16 defined in the roof 10 above the rear compartment of the vehicle extends from the bulkhead to the tailgate, then the entire roof panel 11 will not fit in the space between the roof and the floor. In such a case, the roof panel 11 may either form a bulkhead that is not substantially perpendicular to the floor and roof, or the roof panel 11 may be partitioned. If the roof panel 11 is partitioned, then one or more of the partitioned sections (the bulkhead portion of the roof panel 11) may provide the structure for the bulkhead, and the other partitioned section may be retracted (i.e., moved forward). Each section may be hingedly connected to an adjacent partition, thereby allowing a first section to be retracted (i.e., moved towards the front of the vehicle such as by sliding) while a second section is pivoted downwardly to mate with a bulkhead frame and form a bulkhead. Illustratively, FIG. 9 conceptually provides a side view of a vehicle with a retractable roof panel 21 in a closed position. A compartment 22 is also shown for receiving the panel 21 upon retraction. As another example, FIG. 10 conceptually provides a side view of a vehicle with another retractable roof panel 23 in an opened position. The panel 23 of FIG. 10 moves above the front compartment roof of the vehicle.

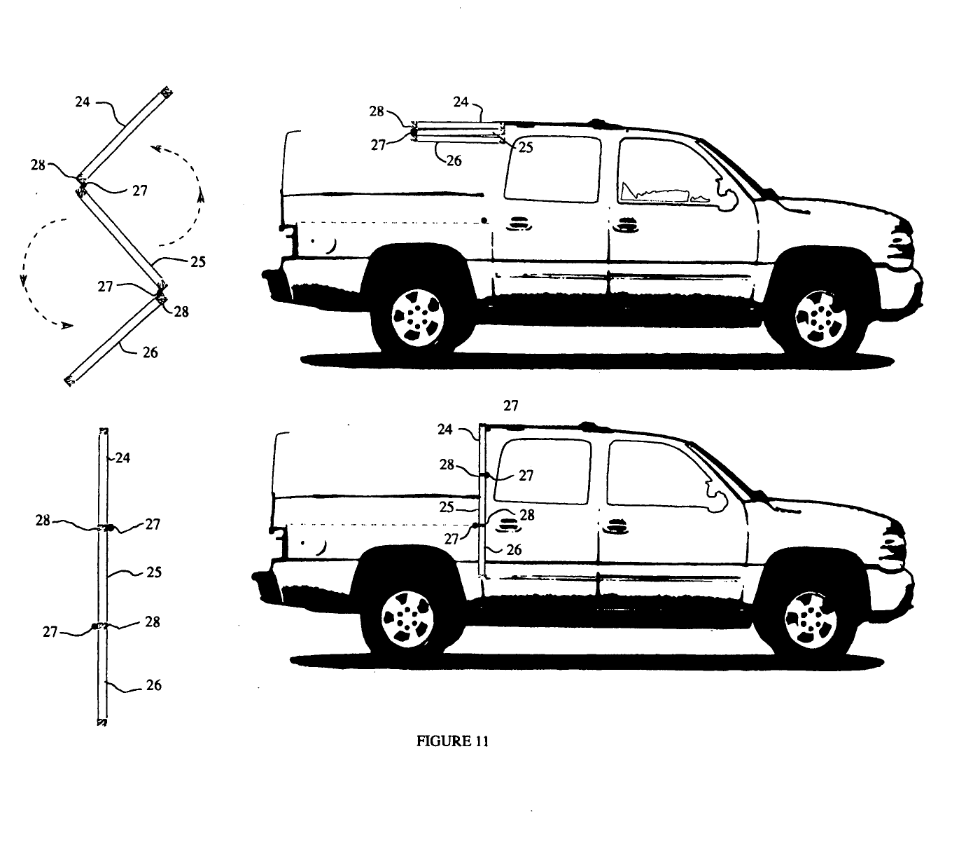

Referring now to FIG. 11, side views of a vehicle with a roof panel having a plurality of hingedly joined sections 24-26 are shown. The panel includes a plurality of hinges 27-28 in addition to hinges 14 for enabling folding and maneuvering of the panel. Advantageously, the flexibility afforded by the plurality of hinges enables the panel to be folded to avoid obstacles, such as passenger seats, which may be in the rear compartment. Thus, the burden of collapsing or removing obstacles to erect the bulkhead is avoided. After avoiding the obstacles and being maneuvered into proximity with the bulkhead frame, the panel sections may be unfolded and locked against the bulkhead frame. Subsequently, the panel may be unlocked and released from the bulkhead, folded to avoid obstacles, maneuvered into position at the roof opening, unfolded and locked into place at the roof.

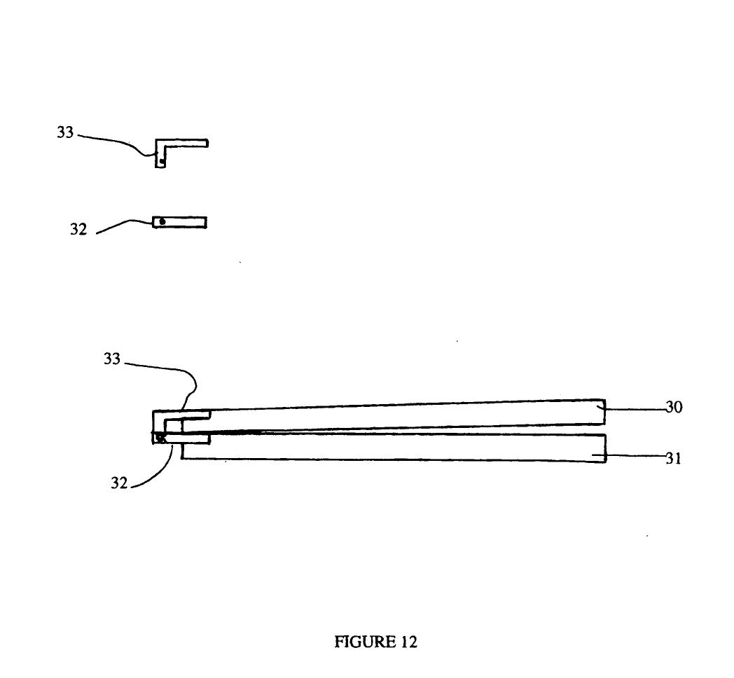

In another alternative embodiment, the roof panel may be comprised of a plurality of panels, such as an exterior panel 30 and an interior panel 31, each of which may be hingedly attached 32, 33 to the fixed roof as conceptually illustrated in FIG. 12. A lock mechanism may be provided to lock the plurality of panels together, to the fixed roof and to the bulkhead frame 18. Additionally, one or more of the plurality of panels 30, 31 may also be retractable. Thus, for example, while an interior panel 31 is maneuvered into proximity with the bulkhead frame and locked against the bulkhead frame, an exterior panel 30 may be closed, thereby sealing the roof opening. Such a configuration is useful for protecting cargo, pets and passengers in the rear compartment from the elements, while isolating them from the front compartment. Of course, if the exterior panel 30 is independently retractable, it may be retracted to open the roof while the interior panel 31 is locked against the bulkhead frame 18. In another configuration, both the exterior 30 and interior panels 31 may be maneuvered into proximity with the bulkhead frame 18 and locked against the bulkhead frame 18. Using an L-shaped hinge member 33 enables the exterior panel 30 to remain aligned with the interior panel 31, while they are locked against the bulkhead 18 and while they are locked to the fixed roof. Additionally, if the interior and exterior panels are retractable, they may be retracted to open the roof. Thus, the rear compartment may be converted between an open-air configuration and an enclosed configuration using the exterior roof panel, while the interior roof panel is locked against the bulkhead frame.

Some or all hinges and hinged connections of roof panels may be detachable, using detachable hinge connections for automotive applications as is known in the art. Detachability enables removal of the panel or panels for storage and/or maintenance.

In addition to being convertible between an open-air configuration and an enclosed configuration as discussed above, the rear compartment may be convertible between a passenger-carrying compartment and a cargo-carrying compartment. A default configuration may include collapsible or removable passenger seats. Thus, while the passenger seats are in place, the rear compartment functions as a passenger-carrying compartment. When the passenger seats are removed or collapsed, the rear compartment functions as a cargo-carrying compartment.

Those skilled in the art will appreciate that the invention may readily be implemented as original equipment in new vehicles. Additionally, without departing from the scope of the invention, a kit may be provided for aftermarket adaptation of components of the invention to vehicles.

While the invention has been described in terms of exemplary embodiments, those skilled in the art will recognize that the invention can be practiced with modifications within the spirit and scope of the foregoing detailed description. Such alternative embodiments and implementations are intended to come within the scope of the present invention.

1. A motor vehicle having a roof and an interior compartment, said interior compartment including a front area and a convertible rear area, said motor vehicle including:
a roof opening above the rear area;
a roof panel assembly above the rear area, said roof panel assembly being pivotally connected to the roof of the vehicle, and said roof panel assembly being adapted for pivotal movement between a closed position covering the roof opening and an open position; and
a bulkhead frame in the interior compartment between the passenger and rear areas, said bulkhead frame being adapted to receive the roof panel assembly when the roof panel assembly is pivotally moved into the open position.

2. A motor vehicle according to claim 1, said front area being adapted to carry at least a driver and said rear area being enclosed and adapted to carry passengers.

3. A motor vehicle according to claim 1, said front area being adapted to carry at least a driver and said rear area being open-air and adapted to carry passengers.

4. A motor vehicle according to claim 1, said front area being adapted to carry at least a driver and said rear area being open-air and adapted to carry cargo.

5. A motor vehicle according to claim 1, said front area being adapted to carry at least a driver and said rear area being enclosed and adapted to carry cargo.

6. A motor vehicle according to claim 1, said roof panel assembly being adapted to enable locking the roof panel assembly against the bulkhead frame when the roof panel assembly is moved into the open position.

7. A motor vehicle according to claim 1, said roof panel assembly being adapted to enable locking the roof panel assembly to cover the roof opening when the roof panel assembly is moved into the closed position.

8. A motor vehicle according to claim 1, wherein said roof panel assembly includes an interior roof panel and an exterior roof panel.

9. A motor vehicle according to claim 8, wherein said interior roof panel is adapted to lock to said exterior roof panel in a closed position.

10. A motor vehicle according to claim 8, wherein said interior roof panel is adapted to lock to said bulkhead frame in an open position.

11. A motor vehicle according to claim 1, wherein said roof panel assembly is detachably hinged.

12. A motor vehicle according to claim 1, wherein said roof panel assembly includes a means for slidable movement of said roof panel assembly.

13. A motor vehicle according to claim 12, wherein said roof panel assembly is adapted for slidable motion and includes a rear portion hingedly attached to a front portion, said rear portion being adapted to pivot downwardly and lock to said bulkhead frame in a closed position.

14. A motor vehicle according to claim 1, wherein said roof panel assembly includes a plurality of hingedly joined sections.

15. A motor vehicle according to claim 14, wherein said roof panel assembly includes means for retracting the plurality of hingedly joined sections.

16. A motor vehicle according to claim 1, wherein said motor vehicle further includes a tailgate, wherein said roof panel assembly extends from the bulkhead frame to the tailgate when the roof panel assembly is in the closed position.

17. An aftermarket conversion kit for a motor vehicle having a roof and an interior compartment, said interior compartment including a front area and a rear area, said kit including:
a roof panel for pivotal installation above the rear area, said roof panel being adapted for pivotal movement into an open and closed positions;
means for pivotally connecting the roof panel to the roof of the vehicle, and
a bulkhead frame for installation in the interior compartment between the passenger and rear areas, said bulkhead frame being adapted to receive the roof panel when the roof panel is pivotally moved into an open position.

18. A kit according to claim 17, said kit further including
a bulkhead lock adapted to enable locking the roof panel against the bulkhead frame when the roof panel is pivotally moved into the open position;
a bulkhead seal adapted to provide a seal between the roof panel and the bulkhead frame when the roof panel is locked against the bulkhead frame;
a roof lock adapted to enable locking the roof panel at the roof when the roof panel is in the closed position; and
a roof panel seal adapted to provide a seal between the roof panel and the roof when the roof panel is locked at the roof.
